(19) United States
(12) Patent Application Publication
(10) Pub. No.: US 2002/0135879 A1
(43) Pub. Date: Sep. 26, 2002

(54) Super high resolution optical resonator

(76) Inventor: Valdimir Pogrebinsky, Campbell, CA (US)

Correspondence Address: WEISS & MOY PC, 4204 NORTH BROWN AVENUE, SCOTTSDALE, AZ, 85251, US

(21) Appl. No.: 09/788,242

(22) Filed: Feb. 20, 2001

(51) Int. Cl. H01S 3/08; G02B 27/00

(52) U.S. Cl. 359/578; 359/577; 372/99

(57) ABSTRACT

A super high resolution optical resonator comprising a Fabry-Perot cavity and an intracavity diffraction grating which is operated in a non-zero diffraction order. The diffraction grating is of transmission or reflection type, blazed, single or multiple order. The resonant cavity can comprise two independent mirrors, multiple mirrors, or an optical resonator based on an optical fiber and one or more intracavity diffraction gratings operated in non-zero diffraction order inserted between the two or more mirrors or portions of the fiber, respectively.

In a preferred embodiment, the diffraction grating is not in contact with one of the mirrors or the optical fiber. In another preferred embodiment, the diffraction grating is in contact with one of the mirrors or the optical fiber. In another preferred embodiment, the diffraction grating is part of one of the mirrors or the optical fiber. The width of the resonance is reduced by more than two orders of magnitude compared to prior art optical resonators and all diffraction orders except one of the diffraction grating are suppressed.

### BACKGROUND OF THE INVENTION

1. Field of the Invention

This invention relates generally to optical filters of high resolution and, more specifically, to super high resolution optical resonators for use in optical spectrum analyzers, in lasers, and in wavelength multiplexers and demultiplexers in optical data communications.

2. Description of the Prior Art

Optical filters define the power of an electromagnetic field as a function of the actual wavelengths (frequencies) emitted or received by a certain device. The devices used for analyzing the optical spectrum of a field (source) are called optical spectrum analyzers. Such devices are based on the properties of some optical instruments of being highly sensitive to the wavelength of the incident light. The most used instruments for wavelength analysis are dispersion prisms, Fabry-Perot interference filters and diffraction gratings.

In general, Fabry-Perot resonators—optical resonators, interference filters, and lasers—are based on the effect of optical resonance of an assembly of highly reflective mirrors. By introducing a Fabry-Perot cavity inside an optical system, the reflection and transmission of the cavity is highly dependent on the spectrum. Each wavelength has a specific resonance given by the optical path difference between the mirrors forming the cavity. By varying the optical path and “scanning” the spectrum or “tuning” on various wavelengths and measuring the transmitted or reflected power, one can measure accurately the spectrum of the source based on the sampling given by the cavity.

General applications of optical filters are optical spectrum analysis in the fields of imaging, color (wavelength) separation, lasers (continuous and pulsed), and optical processing. Further applications are wavelength multiplexing and demultiplexing, tunable and fixed wavelength lasers, and data processing. The introduction of wavelength division multiplexing (WDM) technology, in which several channels are simultaneously transmitted along a single fiber but with each channel located at a different wavelength, has had a profound impact on the telecommunications infrastructure. The multiple wavelengths provide higher capacity along fiber links and wavelength-dependent routing through a network. As the technology of choice for dramatically upgrading the capacity of fiber systems at a reasonable cost, WDM growth has exploded in recent years. Worldwide sales are projected to grow from $3.7 billion in 1999 to $15.9 billion in 2001.

The limitation of prior art Fabry-Perot optical resonators resides in the fact that their practical resolution is typically limited to a finesse not exceeding 100 due to practical limitations (mirror's roughness, shape, misalignments, etc.).

The “finesse” is a convenient measure, which characterizes the sharpness of a resonance; it is the ratio of the resonance spacing to the width of a bright resonance between the half-intensity points.

The finesse is a non-dimensional quantity, dependent only on the reflectivity of the Fabry-Perot mirrors.

It is known to those skilled in art that the chromatic resolving power of a Fabry-Perot interferometer is proportional to the length of the cavity; it would appear that, in order to have better wavelength resolution for the same —limited—reflectivity of the mirrors defining the finesse, an easy approach would be to enlarge the cavity. Unfortunately, the resonance spacing called “free spectral range” is inversely proportional to the optical length of the cavity. Therefore, by simply increasing the cavity's length, one can obtain sharper resonances, but closer spaced, so the number of “available” independent wavelengths to be resolved cannot be improved, and trade-offs must be done.

Moreover, a longer cavity would be more sensitive to external influences like temperature and vibrations, as well as more sensitive to misalignments

Limited finesse of prior art optical filters has had a profound impact on transmission rates in optical data communication. Data transmission rates are limited by the number of channels with the number of channels being dictated by the channel spacing limitation. The channel spacing limitation, in turn, depends on the sharpness of the resonances and their spacing, which allows only for a certain number of channels.

Therefore a need existed to provide a practical and inexpensive optical resonator of high optical resolution without sacrificing the stability and tunability of the device. A further need existed to provide a practical and inexpensive optical resonator which significantly exceeds the optical resolution of prior art optical filters. A further need existed to provide a practical and inexpensive optical resonator in which all resonances except one are suppressed.

### SUMMARY OF THE INVENTION

In accordance with one embodiment of the present invention, it is an object of the present invention to provide a practical and inexpensive, stable and tunable optical resonator of high optical resolution.

It is another object of the present invention to provide a practical and inexpensive optical resonator with significantly improved optical resolution.

It is another object of the present invention to provide a practical and inexpensive optical resonator in which all resonances except one are suppressed.

It is another object of the present invention to provide a Fabry-Perot optical resonator with an intracavity diffraction grating wherein the intracavity diffraction grating works in a non-zero diffraction order.

### BRIEF DESCRIPTION OF THE PREFERRED EMBODIMENTS

In accordance with one embodiment of the present invention, an optical resonator is disclosed which comprises a Fabry-Perot cavity and an intracavity diffraction grating which is operated in a non-zero diffraction order. The diffraction grating is of transmission or reflection type, blazed (due to practical limitations), single or multiple order.

In accordance with another embodiment of the present invention, an optical resonator is disclosed which comprises an optical cavity having two independent mirrors and an intracavity diffraction grating which is operated in non-zero diffraction order. The diffraction grating can be either not in contact or in contact with one of the independent mirrors or can be part of one of the independent mirrors. The mirrors can be either planar or nonplanar.

In accordance with another embodiment of the present invention, an optical resonator is disclosed which comprises an optical cavity having more than two mirrors and an intracavity diffraction grating which is operated in non-zero diffraction order. The diffraction grating can be either not in contact or in contact with one of the mirrors or can be part of one of the mirrors. The mirrors can be either planar or nonplanar.

In accordance with another embodiment of the present invention, an optical resonator is disclosed which comprises an optical cavity having more than two mirrors and more than one intracavity diffraction grating which are operated in non-zero diffraction order. The diffraction gratings can be either not in contact or in contact with the mirrors or can be part of the mirrors. The mirrors can be either planar or nonplanar.

In accordance with another embodiment of the present invention, an optical resonator is disclosed which comprises an optical fiber with an optical cavity and an intracavity diffraction grating which is operated in non-zero diffraction order. The diffraction grating can be either not in contact or in contact with the fiber or can be part of the fiber.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a simplified schematic of a prior art Fabry-Perot resonator.

FIG. 2 is a simplified schematic of an optical resonator with inserted diffraction grating according to the present invention.

FIG. 3 is a graph illustrating the optical resonance spectrum of an optical resonator according to the present invention with a 3.101 μm grating period and of a prior art Fabry-Perot resonator.

FIG. 4 is a graph illustrating the optical resonance spectrum of an optical resonator according to the present invention with a 3.102 μm grating period and of a prior art Fabry-Perot resonator.

FIG. 5 is a graph illustrating the optical resonance spectrum of an optical resonator according to the present invention with a 3.103 μm grating period and of a prior art Fabry-Perot resonator.

FIG. 6 is a table illustrating the calculated resonance width of an optical resonator with inserted diffraction grating according to the present invention and of a prior art Fabry-Perot resonator as a function of grating period.

FIG. 7a is a graph illustrating the optical resonance spectrum of an optical resonator according to the present invention and of a prior art Fabry-Perot resonator for a long optical cavity using “dB” units.

FIG. 7b is a graph illustrating the optical resonance spectrum of an optical resonator according to the present invention and of a prior art Fabry-Perot resonator for a long optical cavity using regular power units.

FIG. 7c is a graph illustrating the enlarged optical resonance spectrum of an optical resonator according to the present invention and of a prior art Fabry-Perot resonator for a long optical cavity.

FIG. 7d is a graph illustrating the grating function of the intracavity diffraction grating of the optical resonator of the present invention for a long optical cavity.

FIG. 8 is a simplified schematic of an optical resonator with inserted diffraction grating, which is designed to work as a sharp tunable filter according to the present invention.

FIG. 9 is a graph illustrating the tuning range relative to the angle between mirrors and proper adjustment of the cavity's length of an optical resonator according to the present invention.

FIG. 10 is a simplified schematic of an optical resonator according to the present invention comprising more than two mirrors and one intracavity diffraction grating positioned in a ring configuration.

FIG. 11 is a simplified schematic of an optical resonator comprising more than two mirrors and more than one intracavity diffraction grating positioned in a ring configuration according to the present invention.

FIG. 12 is a simplified schematic of an optical resonator according to the present invention comprising more than two mirrors and one intracavity reflection diffraction grating positioned in a ring configuration.

### DETAILED DESCRIPTION OF THE PREFERRED EMBODIMENTS

Referring to FIG. 1, a simplified schematic of a prior art Fabry-Perot optical resonator 10 is illustrated. The Fabry-Perot resonator 10 is comprised of a first partially reflective mirror 11, a second partially reflective mirror 12 having a physical distance L to mirror 11, and an optical transmission medium 13 of refractive index n. The resonance takes place between mirror 11 and mirror 12 with the resonance wavelength given by the optical path difference between mirror 11 and mirror 12. Here, the optical path difference is equal to the physical distance L between mirror 11 and mirror 12 multiplied by the refractive index n of the medium 13. In the prior art Fabry-Perot optical resonator 10, the transmission amplitude T is given by

$$\begin{matrix}T = {t}_{1} {t}_{2} + {t}_{1} {r}_{2} {r}_{1} {ⅇ}^{ⅈ2Δ} {t}_{2} + {{t}_{1} ( {r}_{2} {r}_{1} {ⅇ}^{ⅈ2Δ} )}^{2} {t}_{2} + … \\ = {t}_{1} {t}_{2} / \{ 1 - {r}_{2} {r}_{1} {ⅇ}^{ⅈ2Δ} \}\end{matrix}$$

where t₁, t₂, r₁, r₂, and Δ are the transmission amplitudes of mirrors 11 and 12, the reflection amplitudes of mirrors 11 and 12, and the propagation phase Δ=2πL/λ where λ is the wavelength. The reflection amplitude is analogous.

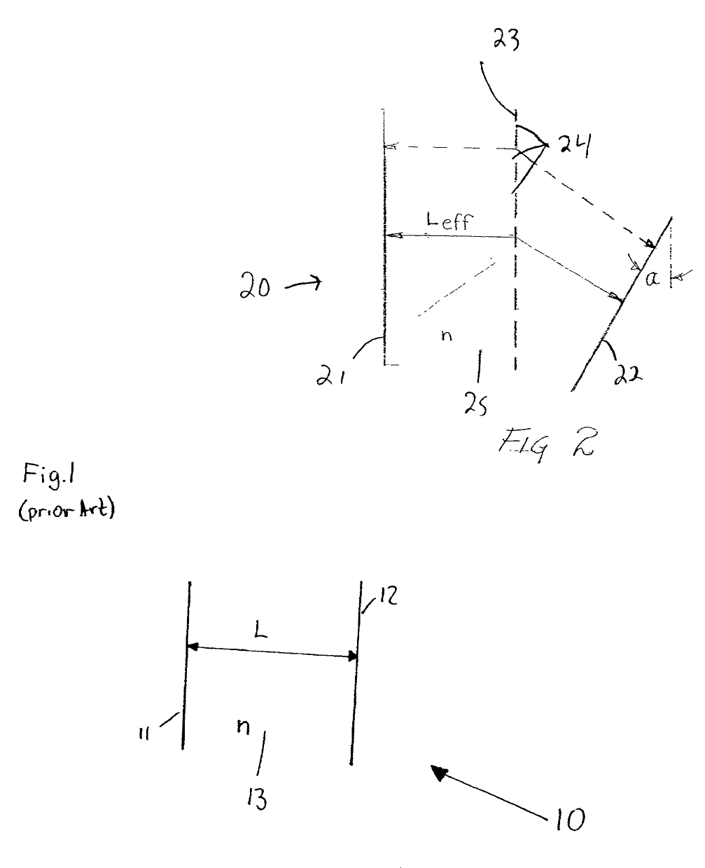

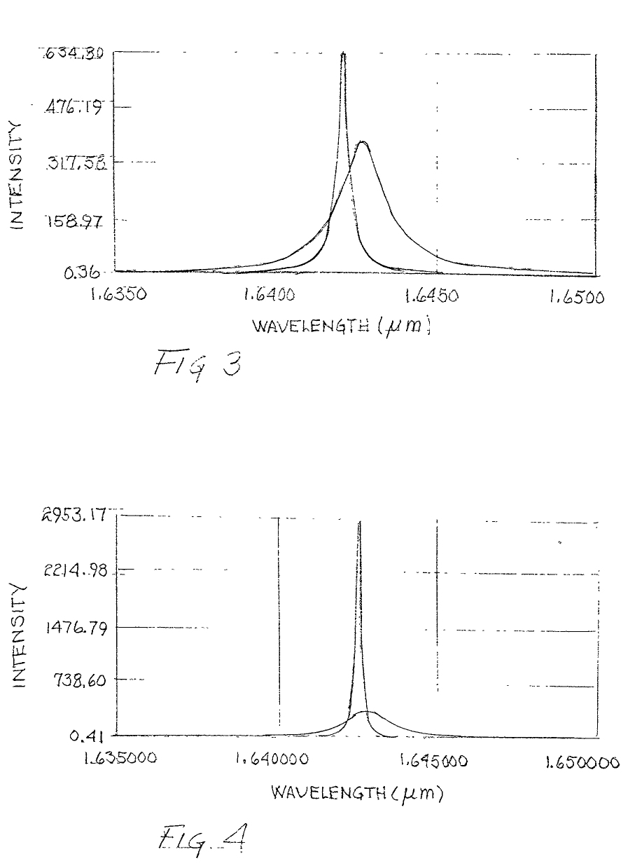

Referring now to FIG. 2, a simplified schematic of an optical resonator 20 according to the present invention is shown. The optical resonator 20 is comprised of a first partially reflective mirror 21, a second partially reflective mirror 22 having an effective physical distance L_{eff} to mirror 21, a diffraction grating 23 inserted between the first mirror 21 and the second mirror 22 and having equally spaced apertures 24, and an optical transmission medium 25 of refractive index n. For example, mirror 21 and mirror 22 have an optical reflectivity of 20%-90%. The spacing between apertures 24 of diffraction grating 23 is referred to as grating period d. It should be understood that diffraction grating 23 can be of either transmission or reflection type, blazed, single or multiple order.

In the optical resonator 20 according to the present invention with an intracavity diffraction grating 23 the transmission amplitude T is given by

$$T = \frac{{t}_{1} {t}_{2}}{1 - {G}^{2} {r}_{1} {r}_{2} {ⅇ}^{ⅈΔ}}$$

where G is the grating function. Once in a cavity, the “reflection amplitude factor” r₁r₂ is multiplied by the grating function G. For a long cavity, the Fabry-Perot resonances are quite narrow by themselves, but they are very closely spaced, as discussed above. The grating function G is also narrow (the more so the wider the beam relative to grating period). The cavity resonates when the denominator is close to zero. This can happen only if the grating function G is unity—at its narrow peak. The tuning is performed easily by changing the angle α of mirror 22, this picks a different wavelength λ for which the grating function G has a peak. For diffraction order(s) m≧1 (non-zero diffraction order), the grating function peak is at λₘ=(d/m) sin αₘ with λₘ being the m-th resonance wavelength of optical resonator 20. Since the resonance takes place between mirror 21 and mirror 22 with the resonance wavelength of order m given by the effective optical path difference between mirror 21 and mirror 22, the cavity length must also be adjusted to the resonance. The effective optical path difference is equal to the effective physical distance L_{eff} between mirror 21 and mirror 22 multiplied by the refractive index n of medium 25. The use of intracavity diffraction grating 23 involves a double refinement of the spectral sensitivity: by the optical resonance between mirror 21 and mirror 22 and by the diffraction grating 23. Thus, optical resonator 20 has a finesse which is significantly enhanced over prior art optical filters and furthermore, all diffraction orders m except one of diffraction grating 23 are suppressed. A further advantage is an almost unlimited ability to tune without degradation of performance.

The several advantages of optical resonator 20 according to the present invention can be best explained with reference to the prior art Fabry-Perot resonator 10 shown in FIG. 1. First, the advantage of significantly enhanced wavelength resolution, and second, the advantage of suppression of all diffraction orders m except one of optical resonator 20 according to the present invention are discussed in detail.

For both optical resonator 20 according to the present invention and prior art optical resonator 10, any change of wavelength λ will have an effect on the resonance in the cavity. However, this effect will be greatly enhanced by intracavity diffraction grating 23 in resonant cavity 20 of the present invention. The physical principle is that the sensitivity of the diffraction grating 23 to the optical spectrum, having an angular dependence with the wavelength λ, will interact with the resonance, refining the modes of the optical cavity 20. Moreover, due to the intrinsic sensitivity of any optical resonator to internal disturbances, the optical filtering will be greatly enhanced by the standing wave phenomena. The greatly enhanced finesse of optical resonator 20 over prior art optical resonator 10 is demonstrated in the following figures.

Referring to FIG. 3, a calculated optical resonance spectrum 31 of an optical resonator 20 according to the present invention with a 3.101 μm grating period is shown in comparison with an optical resonance spectrum 32 of a prior art Fabry-Perot resonator 10. Referring now to FIG. 4, a calculated optical resonance spectrum 41 of an optical resonator 20 according to the present invention with a 3.102 μm grating period is shown in comparison with an optical resonance spectrum 42 of a prior art Fabry-Perot resonator 10. Referring to FIG. 5, a calculated optical resonance spectrum 51 of an optical resonator 20 according to the present invention with a 3.103 μm grating period is shown in comparison with an optical resonance spectrum 52 of a prior art Fabry-Perot resonator 10. The cavity length for all calculations is 30.3 μm.

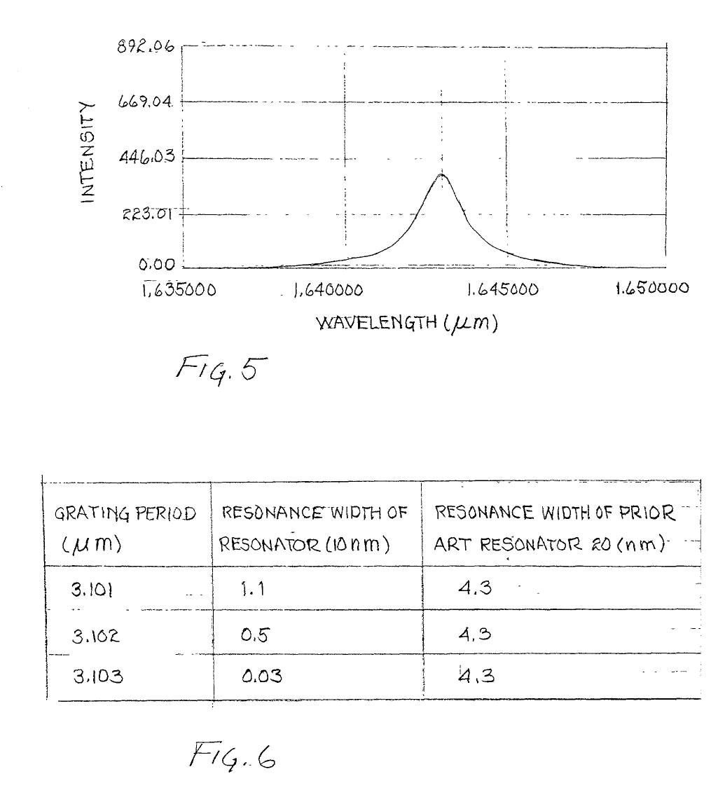

Referring now to FIG. 6, a table summarizes the resonance widths as obtained by the calculations. As indicated, optical resonator 20 of the present invention can reduce the width of the resonance by more than two orders of magnitude compared to prior art optical resonator 10. Thus, optical resonator 20 of the present invention allows an improvement in optical resolution of better than two orders of magnitude when compared to prior art optical resonator 10. Even better results could be achieved by the optimization of the optical set-up parameters.

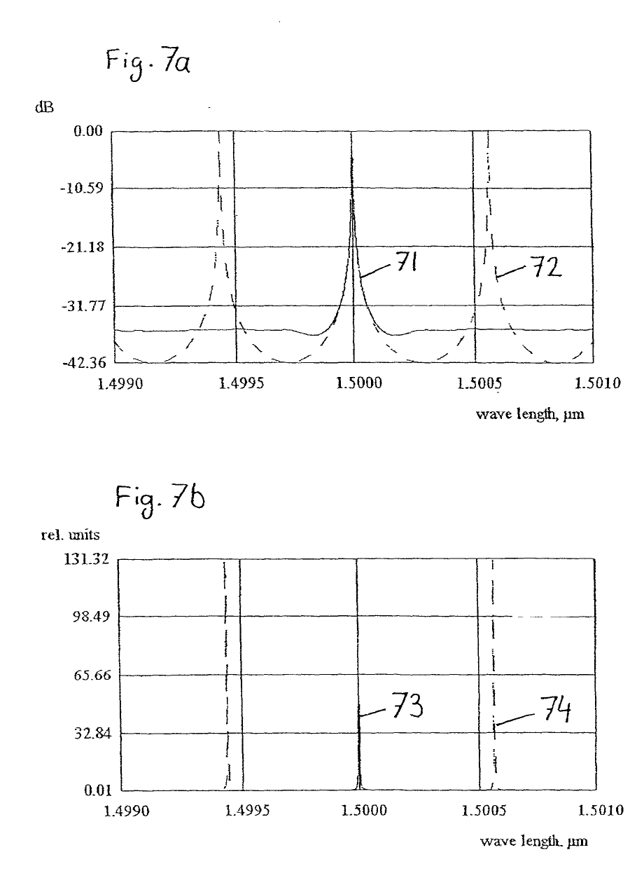

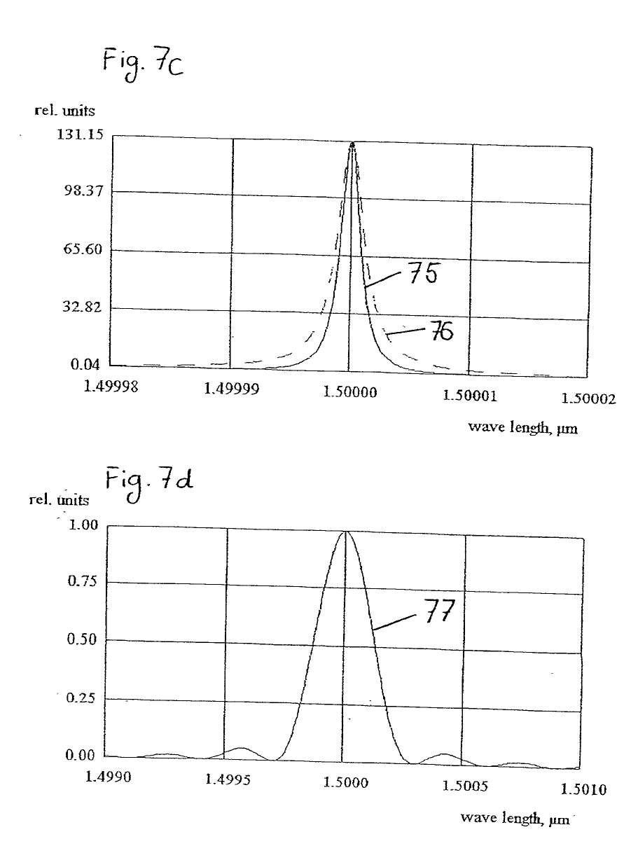

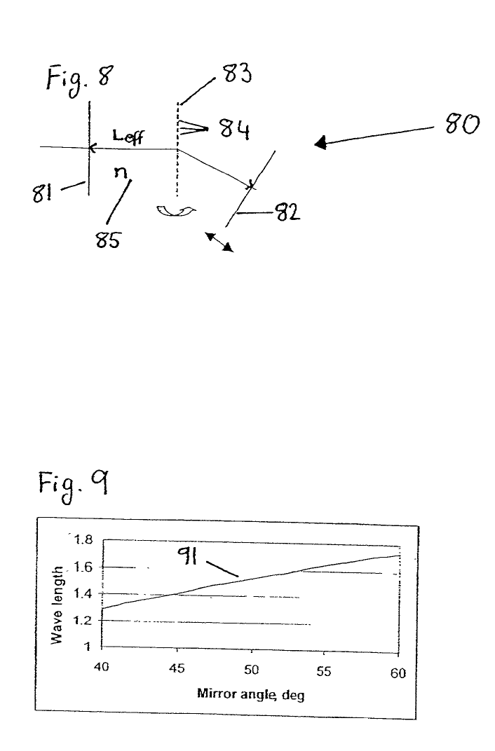

The further advantage of suppression of all diffraction orders m except one is illustrated in the following based on the example of a long optical cavity. Referring now to FIG. 7a, the calculated optical resonance spectrum 71 of an optical resonator 20 according to the present invention with inserted diffraction grating is shown in comparison with an optical resonance spectrum 72 of a prior art Fabry-Perot resonator 10 for a long optical cavity using “dB” units. As mentioned earlier, a long optical cavity has very sharp resonances, but the resonances are very close together. In FIG. 7a, one can see the Fabry-Perot resonances as well as the spacing. The objective is to have narrow resonances, but widely spaced, which, for a prior art Fabry-Perot resonator 10 can not be accomplished. Note that the spacing of the resonances in the optical resonance spectrum 72 of prior art resonator 10 is only 0.6 nm, thus in practice, many resonances will pass the filter. On the other hand, the inserted diffraction grating 23 of the optical resonator 20 effectively “kills” any unwanted resonance, as shown in the optical resonance spectrum 71.

Referring now to FIG. 7b, a calculated optical resonance spectrum 73 of an optical resonator 20 according to the present invention with inserted diffraction grating is shown in comparison with an optical resonance spectrum 74 of a prior art Fabry-Perot resonator 10 for a long optical cavity using regular power units. In FIG. 7b the same correlation between the insertion of the diffraction grating 23 in the optical resonator 20 and the elimination of unwanted resonances (spectrum 73) as in FIG. 7a is shown.

Referring now to FIG. 7c, an enlarged calculated optical resonance spectrum 75 of an optical resonator 20 according to the present invention with inserted diffraction grating is shown in comparison with an enlarged optical resonance spectrum 76 of a prior art Fabry-Perot resonator 10 for a long optical cavity. The improvement on the resonance itself caused by inserting the diffraction grating 23 in the optical resonator 20 can be noticed in spectrum 75 in comparison with the resonance of the prior art Fabry-Perot resonator shown by spectrum 76, in addition of filtering the unwanted resonances, see FIG. 7a and FIG. 7b.

Referring now to FIG. 7d, the grating function 77 is shown to demonstrate the filtering characteristics of the diffraction grating 23 inserted in the optical resonator 20 of the present invention using a long optical cavity.

It should be understood that optical resonator 20 exemplifies only one possible embodiment of the invention using two independent mirrors 21 and 22 and an intracavity diffraction grating 23 which can be either not in contact or in contact with one of the two independent mirrors 21 and 22 or can be part of one of the two independent mirrors 21 and 22.

A number of different embodiments of this invention, based on the schematic shown in FIG. 2, are possible.

Thus, in one embodiment of the present invention, an optical resonator 80 according to the present invention is designed to work as a sharp tunable filter, as shown in FIG. 8. The optical resonator 80 is comprised of a first partially reflective mirror 81, a second partially reflective mirror 82 which can be translated and having an effective physical distance L_{eff} to mirror 81, a diffraction grating 83 inserted between the first mirror 81 and the second mirror 82, being able to be rotated, and having equally spaced apertures 84, and an optical transmission medium 85 of refractive index n. For example, mirror 81 and mirror 82 have an optical reflectivity of 20%-90%. The spacing between apertures 84 of diffraction grating 83 is referred to as grating period d. The rotation of the inserted diffraction grating 83 shifts the position of the resonance, due to the relative variation of the grating period according to a cosinusoidal relation. Due to the low incidence angle, the cosine has a small variation, allowing for a very fine variation of the period.

For a larger tuning range, a combined movement of the diffraction grating 84 and the second partially reflective mirror 82—rotation and translation or an equivalent rotation around an eccentric position—must be done, in order to keep the Fabry-Perot resonance coupled with the grating period. Referring now to FIG. 9, a graph 91 of the tuning range relative to the angle between mirrors (changing the angle tunes the grating) and proper adjustment of the cavity's length is illustrated.

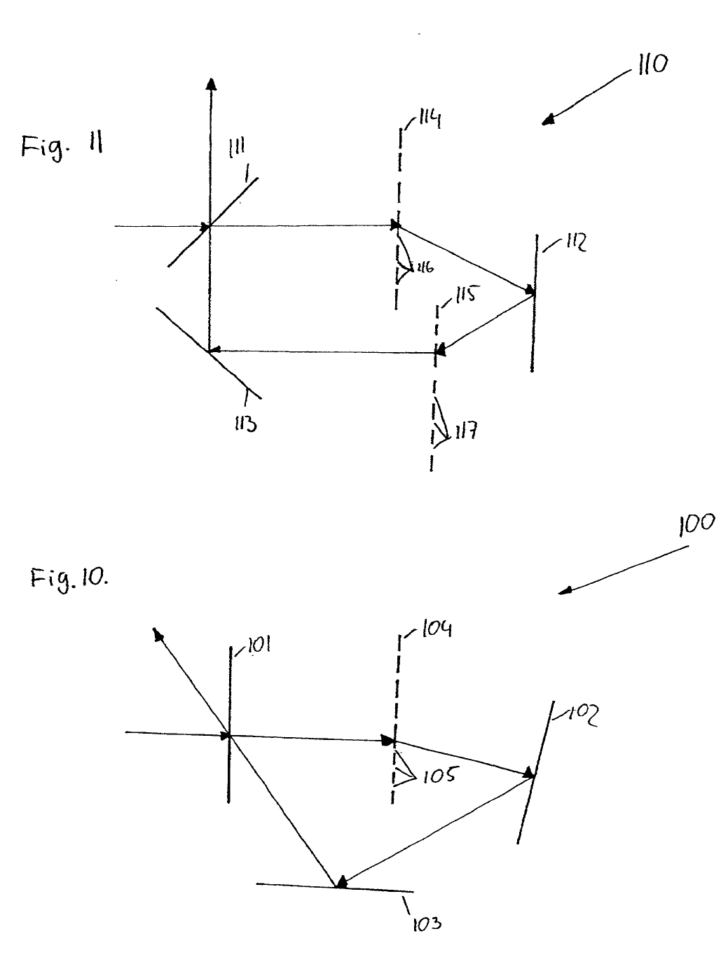

In another embodiment of the present invention, an optical cavity may be provided having more than two mirrors, for example, positioned in a ring configuration and one intracavity diffraction grating, which is operated in non-zero diffraction order. Referring now to FIG. 10, a simplified schematic of an optical resonator 100 according to the present invention is shown. The optical resonator 100 is comprised of a first partially reflective mirror 101, a second totally reflective mirror 102 and a third totally reflective mirror 103, a diffraction grating 104 inserted between the first mirror 101 and the second mirror 102, and having equally spaced apertures 105. For example, mirror 101 has an optical reflectivity of 20%-90%. The spacing between apertures 105 of diffraction grating 104 is referred to as grating period d. It should be understood that diffraction grating 104 can be of either transmission or reflection type, blazed, single or multiple order. The diffraction grating can be either not in contact or in contact with one of the mirrors or can be part of one of the mirrors. The optical resonator 100 has a finesse which is significantly enhanced over prior art optical filters and furthermore, all diffraction orders m except one of diffraction grating 104 are suppressed.

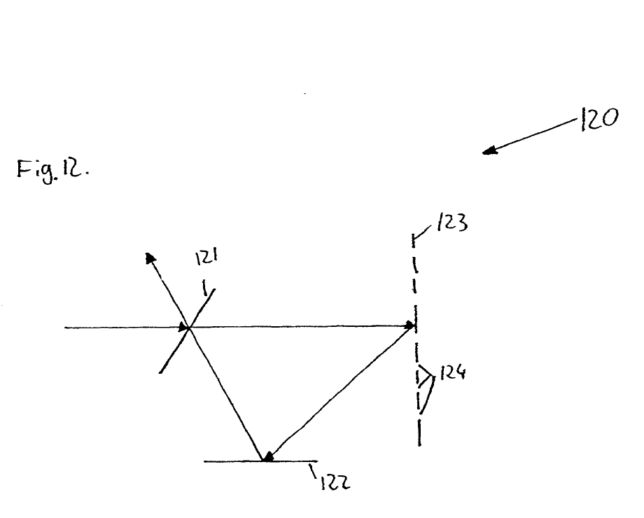

In still another embodiment of the present invention, an optical cavity may be provided having more than two mirrors and more than one intracavity diffraction grating which are operated in non-zero diffraction order, for example, positioned in a ring configuration. Referring now to FIG. 11, a simplified schematic of an optical resonator 110 according to the present invention is shown. The optical resonator 110 is comprised of a first partially reflective mirror 111, a second totally reflective mirror 112 and a third totally reflective mirror 113, two diffraction gratings 114 and 115 inserted between the first mirror 111 and the second mirror 112, and between the second mirror 112 and the third mirror 113, and having equally spaced apertures 116 and 117, respectively. For example, mirror 111 has an optical reflectivity of 20%-90%. The spacing between apertures 116 and 117 of the diffraction gratings 114 and 115, respectively, is referred to as grating period d. It should be understood that diffraction gratings 114 and 115 can be of either transmission or reflection type, blazed, single or multiple order. The diffraction grating can be either not in contact or in contact with one of the mirrors or can be part of one of the mirrors. The optical resonator 110 has a finesse which is significantly enhanced over prior art optical filters and furthermore, all diffraction orders m except one of diffraction gratings 114 and 115 are suppressed. Both ring configurations 100 and 110 are easily be adjustable and tunable.

In still another embodiment of the present invention, an optical cavity may be provided having two mirrors, and one intracavity reflective diffraction grating, which is operated in non-zero diffraction order for example, positioned in a ring configuration. Referring now to FIG. 12, a simplified schematic of an optical resonator 120 according to the present invention is shown. The optical resonator 120 is comprised of a first partially reflective mirror 121, a second totally reflective mirror 122 a reflective diffraction grating 123 inserted between the first mirror 121 and the second mirror 122, and having equally spaced apertures 124. For example, mirror 121 has an optical reflectivity of 20%-90%. The spacing between apertures 124 of the reflective diffraction grating 123 is referred to as grating period d. It should be understood that the reflective diffraction grating 123 can be of either transmission or reflection type, blazed, single or multiple order. The optical resonator 120 has a finesse which is significantly enhanced over prior art optical filters and furthermore, all diffraction orders m except one of the reflection diffraction grating 123 are suppressed.

In still another embodiment of the present invention, an optical fiber may be provided with an optical cavity and an intracavity diffraction grating, which is operated in non-zero diffraction order. The diffraction grating can be either not in contact or in contact with the fiber or can be part of the fiber. In another embodiment of the present invention, an optical resonator in accordance with the invention is a component of a laser. In still another embodiment of the present invention, optical resonators are coupled to form a multiple complex filter. In another embodiment, optical resonators may be cascaded to form a multiple complex filter. It would also be possible to sequence optical resonators to form a multiple complex filter. Examples can be given for various optical configurations used in laser cavities, nonplanar mirrors, confocal resonators and other configurations known to those skilled in art.

While the invention has been particularly shown and described with reference to preferred embodiments thereof, it will be understood by those skilled in the art that the foregoing and other changes in form and details may be made therein without departing from the spirit and scope of the invention.

What is claimed is:

1. An optical resonator comprising:
a Fabry-Perot cavity; and
an intracavity diffraction grating operated in non-zero diffraction order.

2. An optical resonator in accordance with claim 1 wherein said intracavity diffraction grating comprises a transmission grating.

3. An optical resonator in accordance with claim 1 wherein said intracavity diffraction grating comprises a reflection grating.

4. An optical resonator in accordance with claim 1 wherein said intracavity diffraction grating is of single order.

5. An optical resonator in accordance with claim 1 wherein said intracavity diffraction grating comprises a blazed grating.

6. An optical resonator in accordance with claim 1 wherein said intracavity diffraction grating is of multiple order.

7. An optical resonator in accordance with claim 1 wherein said optical resonator is an optical filter.

8. An optical resonator in accordance with claim 1 wherein said optical resonator is one of an optical wavelength multiplexer and demultiplexer.

9. An optical resonator in accordance with claim 1 wherein said optical resonator is a component of a laser.

10. An optical resonator in accordance with claim 1 wherein more than one of said optical resonators are coupled to form a multiple complex filter.

11. An optical resonator in accordance with claim 1 wherein more than one of said optical resonators are cascaded to form a multiple complex filter.

12. An optical resonator in accordance with claim 1 wherein more than one of said optical resonators are sequenced to form a multiple complex filter.

13. An optical resonator comprising:
an optical cavity having two independent mirrors; and
an intracavity diffraction grating operated in non-zero diffraction order.

14. An optical resonator in accordance with claim 13 wherein said intracavity diffraction grating is in optical contact with one of said independent mirrors.

15. An optical resonator in accordance with claim 13 wherein said intracavity diffraction grating is part of one of said independent mirrors.

16. An optical resonator comprising:
an optical cavity having more than two mirrors; and
an intracavity diffraction grating operated in non-zero diffraction order.

17. An optical resonator in accordance with claim 16 wherein said intracavity diffraction grating is in optical contact with one of said mirrors.

18. An optical resonator in accordance with claim 16 wherein said intracavity diffraction grating is part of one of said mirrors.

19. An optical resonator comprising:
an optical cavity having more than two mirrors; and
more than one intracavity diffraction grating operated in non-zero diffraction order.

20. An optical resonator in accordance with claim 19 wherein said intracavity diffraction gratings are in optical contact with said mirrors.

21. An optical resonator in accordance with claim 19 wherein said intracavity diffraction gratings are part of said mirrors.

22. An optical resonator comprising:
an optical resonator based on an optical fiber; and
at least one diffraction grating operated in non-zero diffraction order inserted between portions of said optical fiber.

23. An optical resonator in accordance with claim 22 wherein said intracavity diffraction grating is in optical contact with said optical fiber.

24. An optical resonator in accordance with claim 22 wherein said intracavity diffraction grating is part of said optical fiber.
